(19) United States
(12) Patent Application Publication
(10) Pub. No.: US 2008/0302218 A1
(43) Pub. Date: Dec. 11, 2008

(54) FOUR WHEEL DRIVE HUB LOCK REMOVAL TOOL

(75) Inventors: Scotty R. Kurtz, Clarinda, IA (US); Dalles D. Beery, Maryville, MO (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/760,067

(22) Filed: Jun. 8, 2007

(51) Int. Cl. B25B 7/00

(52) U.S. Cl. 81/415

(57) ABSTRACT

A hub lock removal tool comprises a pliers with special jaws designed to grip and hold, yet not damage, the generally cylindrical outer surface of a hub lock of a motor vehicle. The tool includes stop flanges which limit the pivotal movement of the pliers handles.

### BACKGROUND OF THE INVENTION

In a principal aspect, the present invention relates to a tool designed especially for removal of a hub lock associated with a four wheel drive motor vehicle. The tool is designed to grip and facilitate removal of the hub lock.

A hub lock is employed for a four wheel drive vehicle to enable vacuum technology to effect engagement or disengagement of a wheel to a drive shaft. The description and operation of such a mechanism is disclosed at www.motoralldata.com, by way of example. That description is incorporated herewith by reference.

When repairing the four wheel drive mechanism or system of a motor vehicle, such as described in the reference, it is generally necessary to remove the hub lock associated with the mechanism. The hub lock is typically in the form of a cylinder closed at one end and is designed to fit over the vacuum assist mechanism associated with a four wheel drive. When repairing such a mechanism, a technician may need to remove the hub lock. Manually gripping the hub lock and attempting to remove it by pulling on it is often ineffective, inasmuch as the amount of the force required to effect such an operation often exceeds the physical capacity of the technician or mechanic. Alternatives to manual gripping and removal include gripping with a channel lock or pliers. However, this may damage the cover of the hub lock and defeat the effort to effect the repair. In fact, the information set forth in the noted website reference discourages the use of pliers to remove the hub lock because of the damage that may result.

Thus, there has developed the need to provide some means or tool to effectively remove a hub lock, other than the use of pliers with serrated jaws or manually. This need led to the development of the present invention.

### SUMMARY OF THE INVENTION

Briefly, the present invention comprises a specialty tool and, more particularly, a pliers construction which includes first and second handle members that are constructed with a stop mechanism that limits and thereby controls the travel of the handle members as they are engaged and closed. The opposed jaws of the respective handles each include an arcuate, semi-cylindrical member that is jacketed with an elastomeric material designed to engage a hub lock without damaging the hub lock, while at the same time, enabling a tight grip on the hub lock in order to effect removal thereof from the four wheel drive mechanism of a motor vehicle. The arcuate member attached to each jaw insures that when the jaws are in a closed relation, the hub lock will be surrounded and gripped, and more particularly, the outside cylindrical surface of the hub lock will be engaged. The jaw members thus each include a section in the form of a cylinder surface that is generally co-axial with the cylindrical surface of the hub lock and fits over and in contact with the outside cylindrical surface of the hub lock. Stops associated with the handles of the tool limit the extent of closure of the jaws and handles to thereby avoid pinching the hand of a technician using the tool.

Thus, it is an object of the invention to provide an improved hub lock removal tool.

Further, it is an object of the invention to provide a tool which will avoid engaging the outside surface of a hub lock with serrated jaws and damaging the outside surface of the hub lock.

Further, it is an object of the invention to provide a hub lock removal tool with curved jaw members that tend to conform with the outside surface of a hub lock.

Another object of the invention is to provide a hub lock removal tool which is easy to use, rugged and durable.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of a typical hub lock associated with a four wheel drive mechanism and a mode of engagement therewith by the tool of the invention;

FIG. 2 is a side elevation of the tool of FIG. 1;

FIG. 3 is a top plan view of the tool of FIG. 2;

FIG. 4 is a side elevation of a handle member of the tool of the invention;

FIG. 5 is a top plan view of the handle member of FIG. 4;

FIG. 6 is a side elevation of a jaw member of the tool of FIG. 2;

FIG. 7 is an end view of the jaw member of FIG. 6;

FIG. 8 is an end view of a jacket utilized to cover and protect the jaw member of FIG. 6; and

FIG. 9 is a sectional view of the jacket of FIG. 8 taken along the line 9-9.

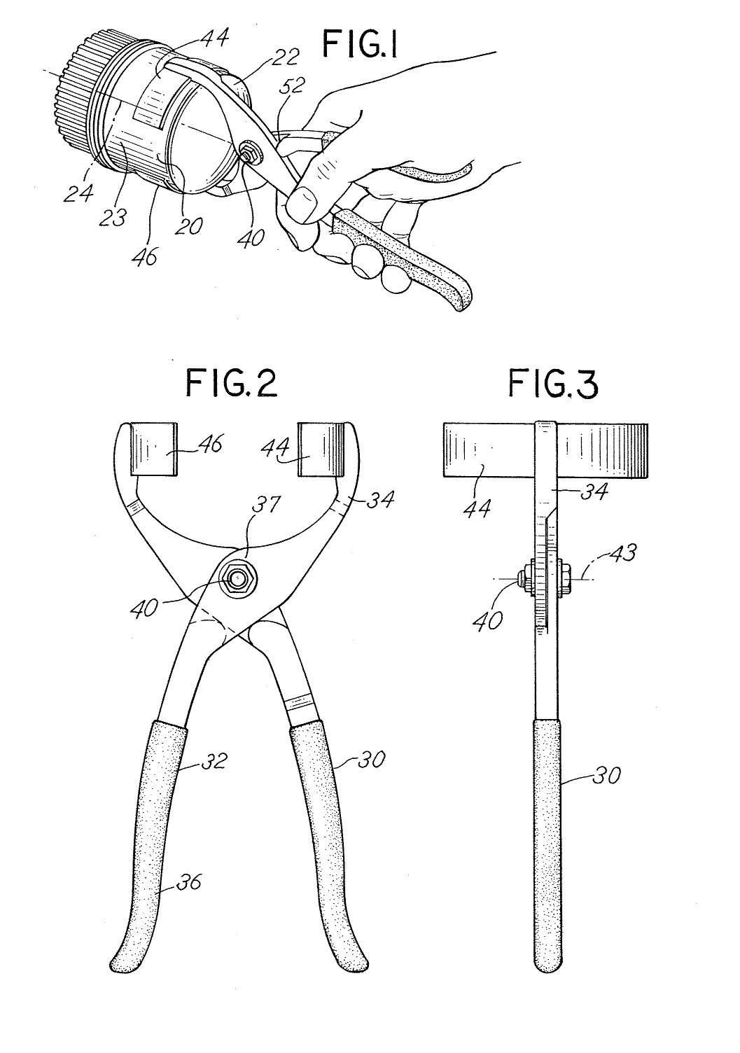

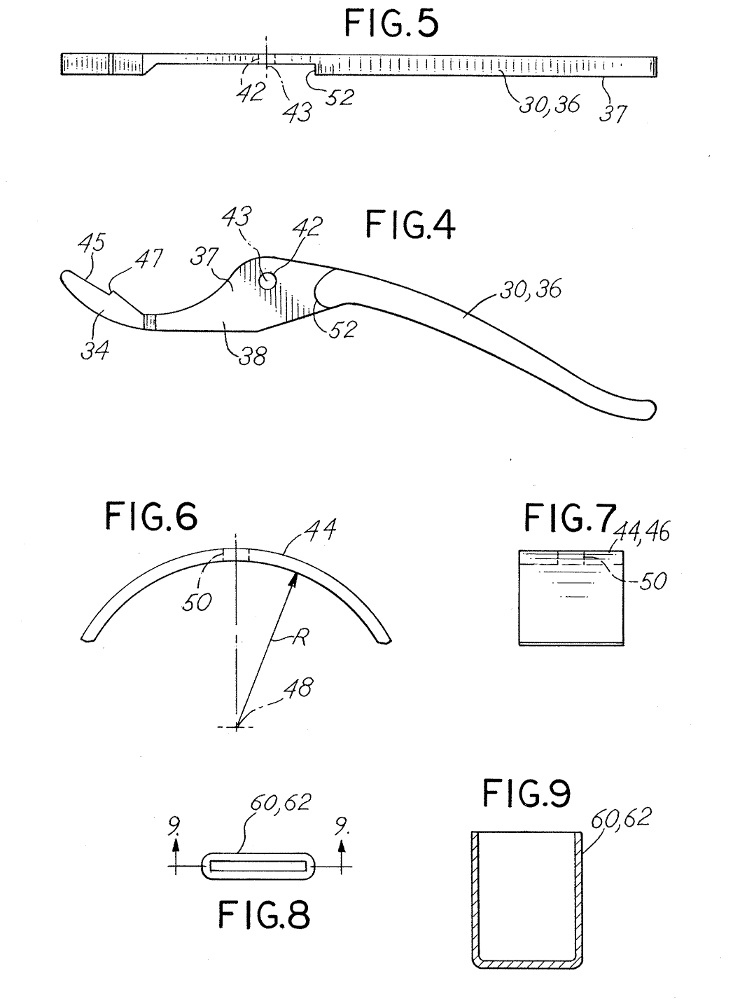

### DESCRIPTION OF AN EMBODIMENT OF THE INVENTION

The tool of the invention is used to engage an outside surface 20 and more particularly, a cylindrical outside surface 20 of a hub lock 22 having a generally cylindrical, tubular shaped portion 23 with a center line axis 24. The tool of the invention includes jaws, as described hereinafter, which, when engaged with the hub lock 22, are generally co-axial with the axis 24, although the cylindrical section 23 typically includes a slight fustoconical taper. The jaws may typically be oriented in a fashion that they will engage the outside surface 20 of the hub lock 22, so as to provide for full contact between the jaw members of the tool and the outside surface 20. The construction or configuration of the jaw members facilitates this gripping action inasmuch as the jaw members are jacketed with an elastomeric that serves a multiplicity of functions. For example, the elastomeric provides for an improved grip and protection from damaging the outside surface as well as full surface contact with the surface 20.

As depicted in the figures, the tool includes a first handle member 30 and a second handle member 32. The handle members 30 and 32 are substantially identical and comprise pliers type handle members having an outer jaw section 34, an inner handle section 36, a center or pivot section 37 intermediate the outer jaw section 34 and handle section 36 connected by a pivot pin or shaft 40 engaged through a center pivot opening 42 shown in FIG. 4 for example.

The handles 30 and 32 may thus pivot about an axis 43. The handles 30 and 32 each include attached thereto, a jaw grip member 44 and 46, respectively. The jaw grip members 44, 46 comprise generally rectangular plates which have been curved or formed into a generally arcuate shape as depicted in FIGS. 6 and 7. Thus, each jaw grip member 44, 46 has an arcuate shape comprising an arc when viewed in cross section transverse to an axis of revolution 48 in the range of approximately 90° to 130°. The radius of the arc is in the range of about 1.25 to 1.75 inches, with a preferred radius of about 1.53 inches. The width of the jaw grip member 44 is generally in the range of about 1 inch, plus or minus 0.25 inches. The jaw grip member 44 includes a center opening or hole 50 which is centered so that each arcuate grip member 44 may be appropriately positioned and aligned on the appropriate jaw end or section 34 of a handle member 30, 32 using the opening 50 to center the jaw grip members 44, 46.

FIGS. 4 and 5 illustrate in greater detail the construction of a handle member 30Q 32. The handle members 30, 32 are substantially identical. Handle member 30 includes a hand grip end 36, center pivot 42, a lateral side surface 45 in the center section 38, a jaw grip section 34 having a flat outer land 49 with a rib stop or surface 47 against which a jaw member, such as jaw grip member 44, may be fitted. The handle member 30 typically has a width on the order of 0.4 inches. The center section 38 typically has a thickness of about 0.2 inches. Thus, when the handle members 30, 32 are joined together or mated by a pivot pin 40 through the respective center openings 42, the handle members 30, 32 will have a uniform total lateral dimension of about 0.4 inches along the length of the handle members 30, 32.

Adjacent the pivot pin opening 42 is a stop or interference flange 52. The flange 52 comprises an arcuate surface generally transverse to the longitudinal dimension of each handle 30, 32 and defining the boundary between the center section 38 and the hand grip end 36. The flange 52 is generally transverse to the lateral side surface 45 and shaped so that the respective flanges 52 of each handle member 30, 32 will engage as the handle members 30, 32 approach each other upon pivoting about pin 40 toward the closed position. Thus, the handle members 30, 32 are prevented from fully approaching each other or pivoting in an unrestricted manner in order to prevent pinching of the hand of a technician closing the jaw grip members 44, 46. The flanges 52 are therefore arcuate enabling contact generally along a tangent to the surface of flanges 52. In sum, the stop members 52 limit the travel of the handle members 30 and 32 toward one another when they are pivoted about the pivot pin 40.

The jaw grip members 44 and 46 are fitted on and welded to the lands 49. Jaw grip members 44, 46 are arranged in opposed relation so that when the jaw grip members 44, 46 are moved to the position limited by the flanges 52, the jaw grip members 44, 46 will be positioned generally co-axially with the surface 20 of the hub lock as previously described.

Each jaw grip member 44 and 46 includes a pair of elastomeric jackets 60, 62 as depicted in FIGS. 8 and 9. Jackets 60, 62 are fitted over the opposite ends of each of the jaw grip members 44 and 46. The jackets 60, 62 are in the form of pockets which are slipped on or which slide over the ends of the respective jaw grip members 44 and 46. The jackets 60, 62 may be removed, replaced and otherwise changed or altered as desired.

The jackets 60, 62 typically have a hardness or durometer reading in the range of 60-100 durometer with a preferable durometer value of about 80. The jackets 60, 62 facilitate the gripping action of the jaw grip members 44 and 46 and also accommodate any discrepancy between the shape of the jaws 44, 46 or the configuration of the jaws 44 and 46 when positioned against the outer cylindrical periphery surface 20 of the hub lock 22. Thus, the tool may be utilized to grip the outer surface of the hub lock 22 and twist the hub lock or pull the hub lock as necessary in order to effect appropriate removal from the four wheel drive system of a motor vehicle.

While there has been set forth an embodiment of the invention, it is to be understood that the invention may be changed or altered without departing from the spirit and scope thereof. For example, the particular configuration of the jaw members may be altered. The dimensional sizing of the jaw members may be altered as may the material comprising the handles, jaws, and jackets. The setting of the stop flanges is designed to limit the closure of the jaws upon reaching a certain pivotal position by engagement of both stop flanges 52 of the opposite handle members 30, 32 and the limit may be altered or changed, depending on the positioning of the flanges 52. Thus, while the embodiment depicted is a useful embodiment, it is to be understood that the invention is limited only by the following claims and equivalents thereof.

1. A hub lock removal tool comprising:
a first pliers handle member including a longitudinal axis extending from a first handle end section to a second gripping end jaw section connected thereto by a third central pivot section including a first pivot axis intermediate the first and second sections, said first pliers handle member further including a pivot limiting flange located in the first handle section and extending transversely to the first pivot axis in the direction of the first pivot axis and located adjacent the central pivot, said first pliers handle member longitudinal axis extending from the first section to the second section;
a second pliers handle member substantially identical to the first pliers member including a pivot limiting flange;
a pivot pin pivotally connecting the first pliers handle member to the second pliers handle member at the first pivot axis for pivoting of the first and second handle members about the first pivot axis with the respective pivot limiting flanges positioned on the first section of the first and second pliers handle members respectively and engageable to thereby limit pivotal movement of the first and second handle members about the first pivot axis toward a closed position;
a first and a second substantially identical arcuate, planar jaw grips attached respectively to the first and second gripping end jaw sections, each said jaw grip comprising a generally rectangular plate configured to form an arc in the range of about 90° to 135° about a grip axis, said grip axis of each jaw grip aligned with the longitudinal axis of the corresponding handle member to which the jaw grip is attached, each said jaw grip forming an arc having a radius in the range of about 1.25″ to 1.75″, said first and second jaw grips arrayed on said respective jaw sections with opposed concave surfaces; and
each said jaw grip including first and second opposite ends with an elastomeric, removable jacket fitted over each end of said jaw grip;
said first pliers handle member, said second pliers handle member, and said first and second jaw grips are coaxial whereby said jaw grips fit coaxially on a hub lock, and
said first and second opposed jaw grips have a substantially equal arcuate dimension and are centered on the respective first and second handle members, said pivot limiting flanges of said first and second handle members positioned to prevent engagement of the opposed jaw grips upon closure of the handle members.

2. The tool of claim 1 wherein the jackets of each jaw grip is an elastomeric characterized by a hardness in the range of about 60 to 100 durometer.

3. The tool of claim 1 wherein each jaw section includes a land with a stop ledge transverse to the longitudinal axis for engaging and aligning a jaw grip.
